(19) United States
(12) Patent Application Publication
(10) Pub. No.: US 2011/0119068 A1
(43) Pub. Date: May 19, 2011

(54) ZONE AWARE TASK MANAGEMENT UTILIZING USER GENERATED PRESENCE HISTORY

(75) Inventors: HUGH E. HOCKETT, Research Triangle Park, NC (US); BRIAN T. PEGRAM, Research Triangle Park, NC (US)

(73) Assignee: INTERNATIONAL BUSINESS MACHINES CORPORATION, ARMONK, NY (US)

(21) Appl. No.: 12/618,989

(22) Filed: Nov. 16, 2009

(51) Int. Cl. G06Q 99/00; G06F 3/01; G01C 21/00

(52) U.S. Cl. 705/1.1; 715/764; 701/207

(57) ABSTRACT

The disclosure presents a solution for identifying one or more zone based tasks within a task manager application of a computing device. The tasks can be comprised of one or more planned activities. In the solution one or more zones can be determined to be associated the identified tasks. Each of the zones can be associated with one or more bounded geographical regions. A task duration for the identified task can be estimated based on user presence historical data associated with the zones. Further, an optimized task list comprising of two or more tasks can be generated from the computed estimates.

### BACKGROUND

The present invention relates to the field of task management and scheduling and, more particularly, to zone aware task management utilizing user generated presence history.

When planning a vacation trip, it is not uncommon for vacationers to have an itinerary of activities and/or tasks for the vacation. Frequently, vacationers can use time management software (e.g., day planners, trip planners, calendars, etc.) to aid in planning activities. This scheduling software can often estimate the duration of an activity/task automatically. Estimates can be used by vacationers to manually or automatically determine an optimized itinerary allowing vacationers to achieve an enjoyable vacation experience.

Estimates can account for travel delays by utilizing global positioning system (GPS) data and other relevant data to determine travel time from a source location to a destination location. That is, vacationers can be assisted in avoiding common delays such as automotive traffic congestion.

While these estimates work well for activities which have a navigation component, the estimates can be inaccurate or non-existent for activities where there is no navigation aspect. That is, estimates can fail to account for times where a vacationer's physical location does not change for an extended period of time (e.g., eating at a restaurant). As such, inaccurate task estimates which comprise an optimized itinerary can fail to address more significant sources of delays. For instance, busy hours at restaurants, long lines at rest stops/facilities, and crowded tourist attractions are sources which can considerably affect an optimized itinerary schedule.

### BRIEF DESCRIPTION OF THE SEVERAL VIEWS OF THE DRAWINGS

FIG. 1A is a schematic diagram illustrating a sequence of scenarios for zone aware task management in accordance with an embodiment of the inventive arrangements disclosed herein.

FIG. 1B is a schematic diagram illustrating a set of application flow models for zone aware task management in accordance with an embodiment of the inventive arrangements disclosed herein.

FIG. 2 is a schematic diagram illustrating a system for zone aware task management in accordance with an embodiment of the inventive arrangements disclosed herein.

FIG. 3A is a schematic diagram illustrating a set of interfaces 310-330 for zone aware task management in accordance with an embodiment of the inventive arrangements disclosed herein.

FIG. 3B is a schematic diagram illustrating an interface 340 for zone aware task management in accordance with an embodiment of the inventive arrangements disclosed herein.

### DETAILED DESCRIPTION

The present invention discloses a solution for zone aware task management utilizing user generated presence history. In the disclosure, zone aware task management can enhance current task estimation and task scheduling technologies. A user defined task within a zone aware task manager can be associated with two or more geographic zones. The geographic zones can be arbitrarily bounded geographic regions. Historical data collected about user presence in the zones can be used to estimate tasks. Based on the constituent zones, an appropriate task estimate can be computed. For instance, an estimated task duration can be computed by averaging together the time durations users spend in each zone. Task estimates can be further used to create an optimized schedule of tasks. For instance, a user can be presented with an ordered task list indicating the most efficient order in which the tasks can be completed.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

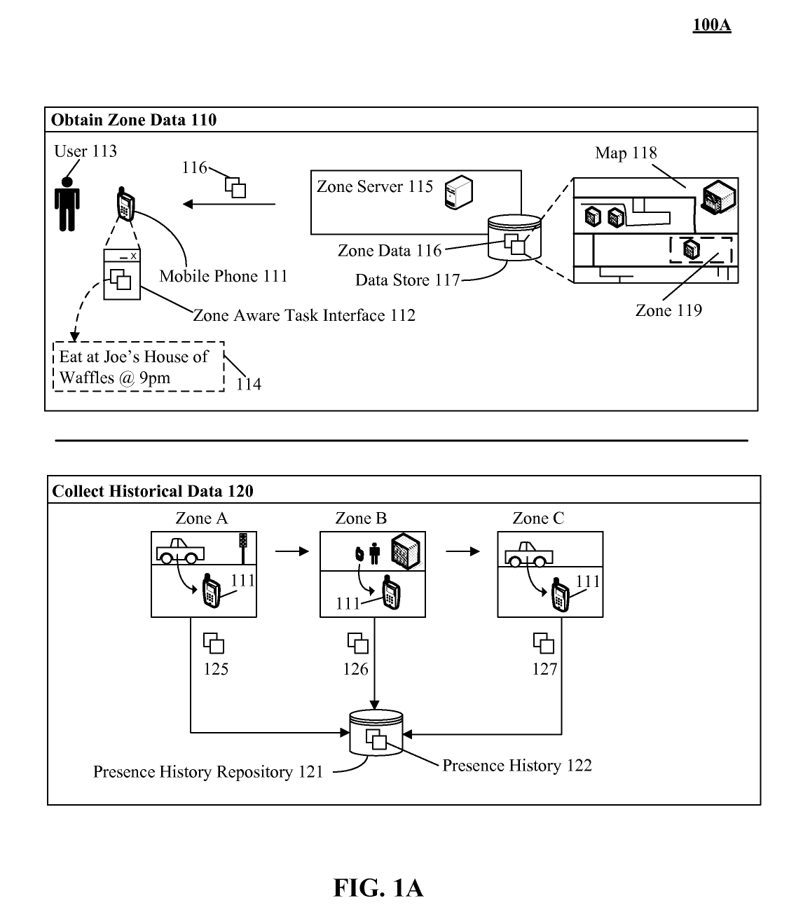

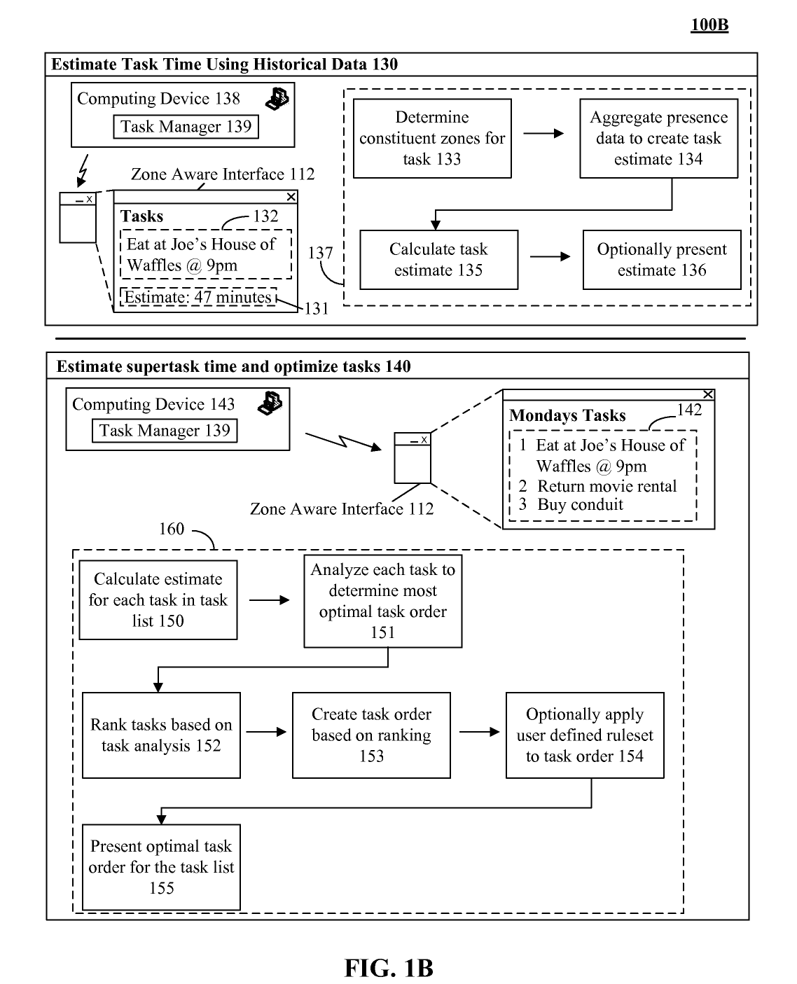

Referring now to the Figures, FIG. 1A is a schematic diagram illustrating a sequence of scenarios 110, 120 for zone aware task management in accordance with an embodiment of the inventive arrangements disclosed herein. As used herein, a task can include one or more planned activities associated with a task management program product (e.g., zone aware task interface 112). In scenario 110, a mobile phone 111 can utilize zone data 116 to perform zone aware task management via zone aware task interface 112. Further, as shown by scenario 120, mobile phone 111 can share presence history 122 collected from presence data 125-127, which provides a zone server 115 with data upon which to base zone-specific time forecasts.

As used herein, zone aware task interface 112 can be one or more interfaces of a task management program product which can execute on mobile phone 111. The interface 112 can be a graphical user interface, a text user interface, a voice user interface, a multimodal interface, a browser interface, and the like. Zone aware task interface 112 can be able to estimate task duration of a zone based task 114 based on presence history data 122. As used herein, zone based tasks can be tasks having one or more activities which can be associated with one or more zones. Thus, a zone based task can have a geospatial nexus to a defined region or zone. In other works, task duration will vary by numerous definable criteria which can be input into a duration forecasting algorithm, where a computationally significant one of the criteria is specific to the geographic region of the corresponding zone. Different zones will produce different forecast results due to zone-specific considerations.

For example, an activity such as eating at a restaurant in zone 119 can be associated with the task “Eat at Joe's House of Waffles @ 9PM”. That is, zone data 116 can be used in enabling a user 113 to interact with zone based tasks via interface 112. It is expected that an activity for eating at a restaurant in a different zone (other than zone 119) would result in different time forecasts for the eating activity. It should be emphasized that zones can be defined at many different levels (can encompass any definable geographic region). A zone can therefore include a single restaurant, all restaurant within a district (for which a zone is defined), and the like. In one embodiment, the zone server 115 can perform statistical analysis operations based on presence history 122 and other relevant data to suggest/determine zone boundaries, where the zone boundaries have common temporal characteristics for in-zone tasks. Additionally, in one embodiment, different categories and/or types of tasks can be associated with different geospatial zone boundaries.

As used herein, zone data 116 can be associated with data store 117. In the scenario, zone data 116 can include information such as zone name, zones dimensions, geographical mapping data 118, and the like. In scenario 110, geographic map 118 can be divided into one or more zones 119. The zone 119 can be defined by one or more features such as political boundaries, property lines, natural boundaries, regional boundaries, structures, and the like. Zone 119 can include two-dimensional and/or three-dimensional geometry. In one instance, zones can overlap and can be distinctly identified via unique identification values.

Correlating zones information (e.g., zone 119) with map data (e.g., map 118—correlations defined by zone data 116, for example) can permit zone based task management to be achieved. Presence enabled devices (a GPS-enabled mobile phone 111, for example) can utilize zone data 116 to dynamically manage zone based tasks. For instance, a restaurant (e.g., Joe's House of Waffles) illustrated within zone 119 in map 118 can be associated with a zone based task 114. Any type of presence sensing technology and presence determination information can be utilized as presence history data 122, which can enable zone server 115 to generate accurate zone-specific forecasts for task durations.

Each zone defined in zone data 116 can be associated with a presence history 122 for users. Presence history 122 can include location, activities within a zone, duration, and the like. For instance, a zone 119 can be associated with mean, median, or other statistically useful measure of the duration of time users spend in a building in zone 119. In another example, zone 119 can be associated with a restaurant and a statistically useful measure of the amount of time users spend in the restaurant. In one instance, presence history 122 can be accumulated automatically by mobile phone 111 utilizing location responsive technologies.

In scenario 110, mobile phone 111 can be a presence enabled device such as a global positioning system (GPS) enabled mobile phone. Map data 118 and zone 119 data can be communicated to mobile phone 111 as zone data 116 in a variety of ways. In one instance, zone data 116 can be communicated to phone 111 as a user enters or exits zones. For instance, when exiting a zone, proximate zone data can be communicated to phone 111 to permit interface 112 to determine user location within a new zone (e.g., real time communication). In another instance, zone data 116 can be communicated in non real-time such as prior to phone 111 activation, during phone 111 software/firmware updates, and the like. In one instance, zone data 116 can conform to an Extensible Markup Language format. In another instance, zone data 116 can be a lightweight proprietary format configured to provide interface 112 with real-time updates.

Once zone data 116 is available to phone 111, interface 112 can determine when and where a user is located within a zone. Based on this determination, interface 112 can automatically manage zone based tasks (e.g., task 114). In one instance, changes in zones can trigger automatic updates to tasks within task interface 112. For example, when a user exits zone 119, task 114 can be updated to reflect a completed status. Further, task 114 reminders can be zone specific, permitting task interface 112 to exhibit a wide range of behaviors based on zone and/or location within a zone.

In scenario 120, task 114 can be associated with a user commuting from Zone A to a restaurant in Zone B and then commuting to Zone C. During task completion, mobile phone 111 can collect presence 125-127 from one or more zones (e.g., Zones A-C). Presence 125-127 can be automatically or manually collected and communicated to presence history repository 121. Presence history 125-127 can be collected based on mobile phone 111 configuration options, interface 112 configuration, repository 117 settings, user established rules, and the like. Presence data 125-127 can be aggregated and stored within presence history repository 121 as presence history 118. For instance, presence data 125-127 such as timestamp data, zone name, zone designation (e.g., zone ID), and duration in zone can be communicated to repository in real-time. In one embodiment, presence data 125-127 can include vector information, location deltas, GPS coordinates, and the like.

Utilizing presence history 122, tasks within Zone A-C can be estimated based on historical data. For instance, presence history 122 can be used to determine a time estimate for task 114. In one embodiment, time durations of user presence in zones which are involved in a zone based task can be statistically averaged together to determine estimated task completion time. Averaging is just one contemplated duration forecasting mechanism and any statistical function can be used (e.g., mean, median, mode, etc.). Statistical processes to discard anomalies from a sample set can be implemented, as can processes to bias statistical computations in any desired manner believed to be relevant for forecasting zone specific task durations. In one instance, zone based task completion estimates or forecasts can be visually presented within interface 112. In one embodiment, interface 112 can also present additional statistical information pertaining to the task completion estimate, such as a standard deviation value, sample size value, and other metrics for variance, error, precision, accuracy, and the like.

In one embodiment, interface 112 can permit creation and modification of zone data 116. In the embodiment, zone data 116 can be user modifiable, permitting a community of users to collaboratively manage zone data 116. In this embodiment, zone data 116 can include user changes to existing zones, user created zones, user customized zones, and the like.

It should be noted scenario 110, 120 is for illustrative purposes only and should not be construed to limit the disclosure in any regard. Communication occurring within scenarios 110, 120 can include real-time and non real-time communications, asynchronous messaging, synchronous communication, wired and/or wireless technologies, and the like. Communication between mobile phone 111 and server 115 can conform to one or more communication models including but not limited to, peer-to-peer, client/server, broadcast, and the like. Further, mobile phone 111 can resent any computing device capable presenting task interface 112 to user 113 and/or capable of gathering presence information for users 113 to be provided to repository 121.

Scenarios 110, 120 can illustrate a client side implementation of zone aware task management. It should be appreciated that other implementations including client driven (e.g., peer to peer), client and server, and server side embodiments are contemplated.

FIG. 1B is a schematic diagram illustrating a set of application flow models 130, 140 for zone aware task management in accordance with an embodiment of the inventive arrangements disclosed herein. In scenario 130, a zone aware task manager 139 can estimate the task time of a zone based task. In scenario 140, a zone aware task manager 139 can utilize task time estimates to compute an optimized task list. As used herein, an optimized task list can include, but is not limited to, one or more tasks arranged in an ordered sequence.

In scenario 130, a zone aware task manager 139 executing on a computing device 138 can present estimates for one or more zone based tasks 132 within zone aware interface 112. The task manager 139 can utilize presence history 118 to estimate the duration of task 132. Flow 137 can illustrate a potential flow model of manager 139 execution. It should be appreciated that flow 137 is for illustrative purposes and should not limit the disclosure in any regard. In step 133, task manager 139 can analyze task 132 to determine constituent zones for the task. In step 134, pertinent presence history data can be used to create a task estimated based on zones determined in step 133. In step 135, the task manager 139 can calculate an estimate for task 132. For instance, the task estimate can include a statistical average (median, mode, etc.) operation for presence history associated with the zones of the task 132. In one embodiment, the task estimate can be computed based on the time of day the task is dependent on. In step 136, the computed task estimate 131 can be optionally presented within zone aware interface 112.

In scenario 140, a zone aware task manager 139 executing on a computing device 143 can present an optimized task list 142 in zone aware interface 112 based on one or more tasks associated with the task manager 139. The task manager 139 can utilize presence history 118 to calculate an optimized task list 142. Optimization can be predicated on task time dependency, location dependency, participant dependency, and the like. Flow 160 can illustrate a potential flow model of task manager 139 execution. It should be appreciated that flow 160 is for illustrative purposes only and should not limit the disclosure in any regard. In step 150, relevant presence history data can be used to calculate a task estimate for each task in task list 142. In step 151, the task estimates can be analyzed to determine the most optimal task order. In step 152, each task can be ranked in order based on task analysis step 151. Ranking can be performed by one or more ranking algorithms, user configuration parameters, system configuration options, and the like. In step 153, a task order can be created based on ranking step 152. In step 154, user defined rulesets can be optionally applied to task order. In step 155, the optimal task order for task list 142 can be presented in zone aware interface 112.

Scenarios 130, 140 are for illustrative purposes only and should not be construed to limit the disclosure in any regard. It should be noted that optimal task order can be achieved through one or more optimization algorithms which can differ from steps illustrated in flow 160. Optimization algorithms can utilize parameters including shortest cumulative task duration, shortest navigation time, and the like.

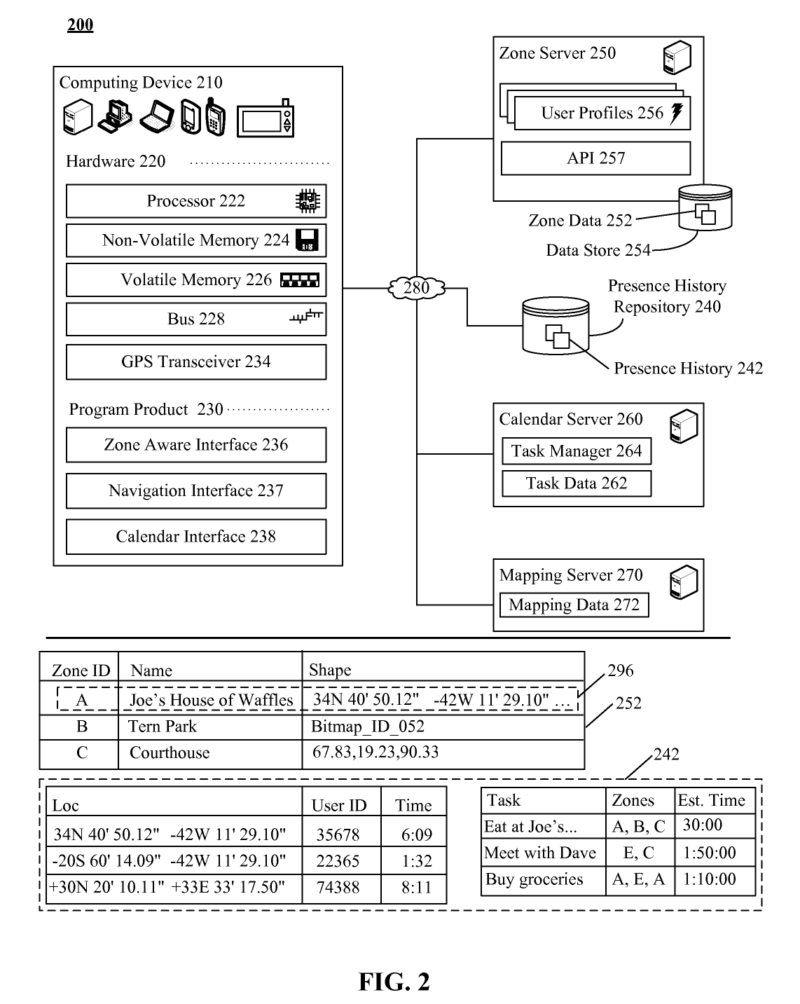

FIG. 2 is a schematic diagram illustrating a system 200 for zone aware task management in accordance with an embodiment of the inventive arrangements disclosed herein. In system 200, a computing device 210 can permit a user to perform zone aware task management. System 200 can include, but is not limited to, server 250, 260, 270, and repository 240. Device 210 can communicate with entities 240-270 via network 280. In one embodiment, communication can occur in real time and/or near real-time. In the embodiment, synchronous and/or asynchronous messaging can be utilized to share zone data 252, history 242, data 262, and data 272.

Computing device 210 can include hardware 220 and program product 230. Hardware 220 can include, but is not limited to, processor 222, non-volatile memory 224, volatile memory 226, bus 228 and Global Positioning System (GPS) transceiver 234. Processor 222 can be a digital logic circuit able to compute estimates for one or more zone based tasks and/or order a task list based on one or more task estimates. Non-volatile memory 224 can permanently store one or more zone based tasks, task estimates, zone based task lists, zone data, presence history, mapping data, and the like. Volatile memory 226 can temporarily store one or more tasks, task estimates, task lists, zone data, presence history, mapping data, and the like. Bus 228 can be a transport interface able to permit communication between one or more system 200. GPS transceiver 234 can be a component able to transmit and receive GPS location data associated with computing device 210. Although GPS is a common position determination mechanism, alterative position determination mechanism can be substituted for the GPS component (transceiver 234) of device 210.

Program product 230 can include, but is not limited to, zone aware interface 236, navigation interface 237, and calendar interface 238. Program product 230 can include task manager applications, calendar software, day planner software, trip planner programs products, GPS navigation software, and the like. In one embodiment, program product 230 can be a software application executing on a GPS navigation device (e.g., automotive navigation system).

Zone aware interface 236 can present task estimates for one or more zone based tasks and/or present an optimized task list (e.g., ordered list). In one instance, zone aware interface 236 can be a remotely executing Web enabled application. Interface 236 can permit customization of user profiles 256, which can be used to alter the behavior of program product 230. In one embodiment, interface 236 can permit simultaneous management of zone based tasks and traditional tasks.

Navigation interface 237 can present zone based task data, mapping information, visual information about zones, presence information, and the like. For instance, navigation interface can be a GPS navigation interface presenting the location of a user and current task being performed.

Calendar interface 238 can present zone based task information, including but not limited to, task name, task description, zones associated with the task, and the like. Calendar interface 238 can conform to traditional calendar interfaces able to visually present activities, tasks, and/or task lists. In one embodiment, calendar interface can be used to present an itinerary for a duration of time based on an optimized task list. For instance, calendar interface 238 can automatically present a daily itinerary based on scheduled tasks in interface 238.

Zone server 250 can enable zone based tasks to be estimated and an optimized task list to be generated. Server 250 can include, but is not limited to, user profile 256, Application Programming Interface (API) 257, and zone data 252. User profile 256 can include, user customized zone information, user sharing configuration options, zone based task management configuration parameters, and the like. Application programming interface 257 can permit seamless communication between device 210, repository 240, and server 260, 270. For instance, API 257 can allow heterogeneous services 260, 270 to communicate natively with server 250.

Zone data 252 stored within data store 254 can be utilized to achieve zone aware task management. Zone data 252 can include data which can be used to define zone names, geographical coordinates, and the like. For instance, data 296 can include GPS coordinates which can define a Zone A.

In one embodiment, zone server 250 can be a Web server. In one configuration of the embodiment, zone server 250 can present user profiles 256 within a Web browser. Further, the profiles 256 can permit tasks to be managed via a Web-based interface (e.g., zone aware interface 236).

Presence history repository 240 can be a remotely located data source allowing presence history 242 to be accessible. In one instance, presence history repository 240 can be associated with zone server 250. Presence history 242 can include timestamp data, zone identifiers, geographical coordinates (not shown), duration in zone time information, duration between entering and exiting a zone, and the like. History 242 can be further utilized to associate zones with tasks and facilitate the creation task time estimates based on component zones.

Calendar server 260 can be a hardware/software computing device able to store and manage tasks. Calendar server 260 can include, but is not limited to, task manager 264 and task data 262. Task data 262 can include a task name, a unique task identifier, task description, and the like. In one embodiment, calendar server 260 can execute a zone aware task manager 264. Zone aware task manager 264 can communicate with API 257 to enable zone based task management to occur.

Mapping server 270 can be a hardware/software computing device able to provide geographical mapping data 272. In one embodiment, mapping server 270 can be a remotely accessible data source such as a third party mapping service. For instance, mapping data 272 can be communicated to zone server 250 to enable tasks to be correlated with zones.

In one embodiment, program product 230 can be available as a Web service. In the embodiment, a subscription based Web service can permit zone based management to be monetized. In one configuration, program product 230 can be configured to permit a legacy computing device lacking presence capabilities to manage zone based tasks. For instance, a traditional task estimate can be improved by utilizing a zone based approach which can be billed per usage. In another configuration, Web service can be monetized by providing a tiered subscription service. That is, a set of features (e.g., task estimation, task list optimization) can be available depending on a paid subscription fee. For instance, product 230 can lack task list optimization functionality when a subscriber chooses a minimum level of service.

Drawings illustrated herein are for illustrative purposes only and should not be construed to limit the disclosure in any regard. In one instance, system 200 can be a service oriented architecture (SOA), permitting a loose coupling of third party system components 240, 250, 260, 270 to give rise to system 200 functionality.

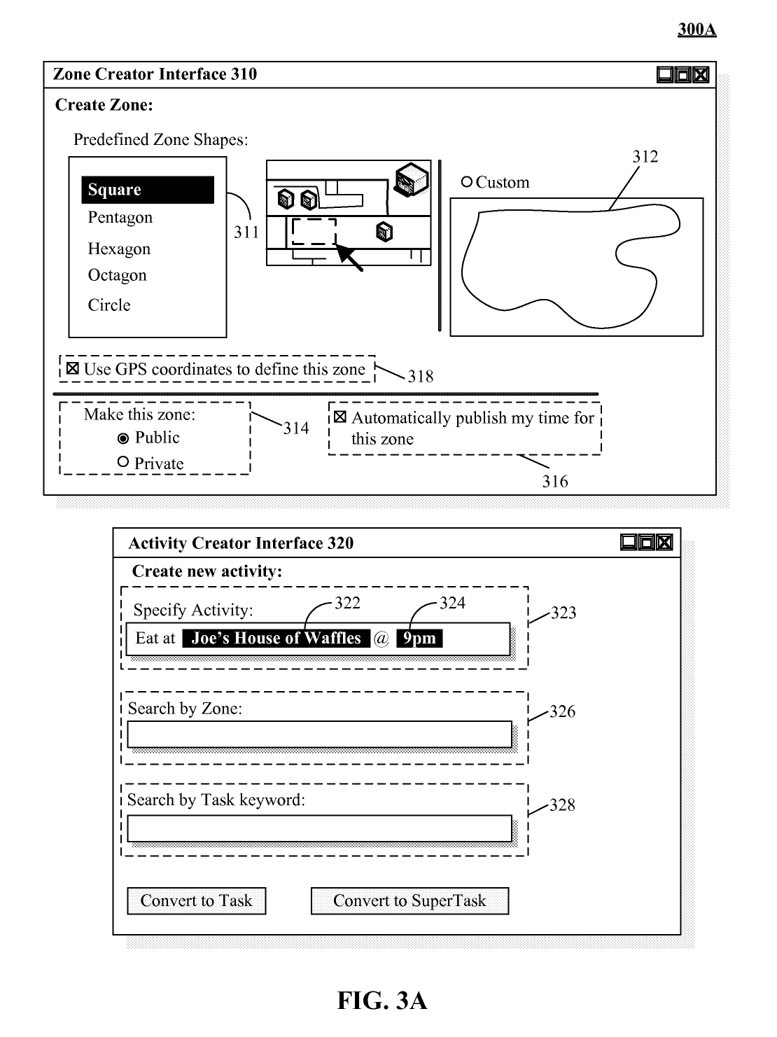

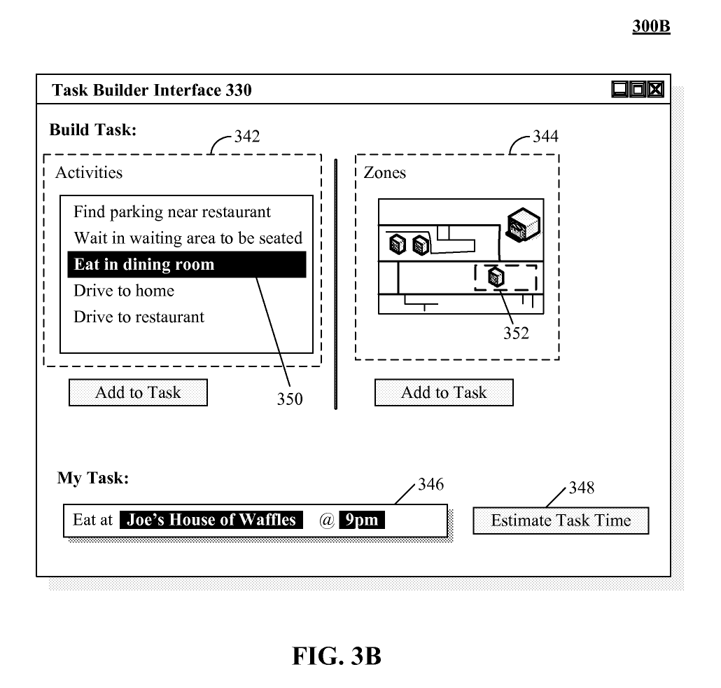

FIG. 3A is a schematic diagram illustrating a set of interfaces 310, 320 for zone aware task management in accordance with an embodiment of the inventive arrangements disclosed herein. In interface 310, a user can be permitted to create zones for a geographic region associated with a zone aware task manager. In one instance, the zone creator interface 310 can be a Web based interface such as an interface screen from a Web enabled application. Interface 320 can permit zone based activities to be created and optionally shared. Tasks can be collectively shared allowing common tasks to be user selectable from a pool of existing tasks. Further, a user community of zone based tasks can be searched using search parameters 326, 328.

In interface 310, user customized zone creation can be facilitated via interface elements 311-318. In the interface 310, zone definitions such as zone shape, sharing settings, and the like can be configured. Interface 310 can present predefined zone shapes allowing users to rapidly create zones. In one instance, predefined shapes can be fixed dimensions which cannot be altered. In another instance, predefined shapes can be user modifiable permitting, resizing, renaming, modifying shape geometry, and the like. Interface element 312 can permit user customized free form shapes to be drawn, allowing for a variety of non-geometric zones to be defined. Further, interface element 318 can allow users to utilize global positioning system (GPS) coordinates to define a zone.

In element 314, sharing of user defined zones can be controlled. Element 314 can permit collaborative zone management to occur where common shapes can be shared among a user community. In element 316, historical user statistics (e.g., presence history) can be automatically published along with zone definition.

In interface 320, a user can create activities which can be linked together to create zone based tasks. In element 323, a user can specify an activity to be created based on one or more inputs. Activity information can include zone name, names of businesses, user addressbook contacts, time information, date information, and the like. In one embodiment, activities can be automatically or manually imported from a user calendar into interface 320. In one embodiment, activity information 322, 324 can be used to automatically determine relevant zones and presence history for a zone based task.

In interface element 326, a new activity can be created from a zone search of common activities in the zone. That is, users can rapidly access previously created tasks by the component zones associated with the task. Element 328 can permit users to search for previously created tasks by task keyword (e.g., restaurant name 322).

Drawings illustrated herein are for illustrated purposes only and should not be construed to limit the disclosure in any regard. Interfaces 310, 320 can be accessible from one or more modalities including, but not limited to, graphical user interfaces (GUI), voice user interfaces (VUI), text based interfaces, mixed-modality interfaces, and the like. Interface 310, 320 can include one or more graphical user interface elements including, but not limited to, text boxes, multiple selection fields, user interactive buttons, radio buttons, and the like.

FIG. 3B is a schematic diagram illustrating an interface 340 for zone aware task management in accordance with an embodiment of the inventive arrangements disclosed herein. In interface 340, zone based tasks can be constructed via user interface elements within interface 340. In one instance, predefined user activities 342 can be linked together to create zone based task 346.

In interface 330, a user can utilize interface elements 342, 344 to create zone based tasks. Element 342 can permit selection of predefined zone based activities. Predefined zone based activities can include, historical activities, community created activities, user created activities, and the like. In one instance, element 342 can be a multiple selection element permitting one or more activities to be associated together to create a zone based task. In one embodiment, predefined users activities 342 can be user modifiable, permitting users to personally customize each task. In this embodiment, user profiles 256 can be used to store user specific task details.

Element 344 can present zone information of selected zone based tasks in element 342. For instance, zone 352 corresponding to a dining room in a restaurant can be presented on a geographical map of the zone (e.g., activity 350). In one instance, geographical map within element 344 can be interactive, allowing the map to be dynamically updated. In one configuration of the instance, user presence history can be visually presented on the geographical map (not shown).

Element 346 can present a zone based task based on user activity 342 selection. In one instance, selection of element 348 can allow task 346 to be automatically estimated. In another instance, task time estimate can be automatically estimated and visually presented in interface 330. In yet another instance, task time estimates can be visually presented in addition to individual time estimates for each selected 342 activity.

Drawings illustrated herein are for illustrated purposes only and should not be construed to limit the disclosure in any regard. Interface 330 can be accessible via one or more modalities including, but not limited to, graphical user interfaces (GUI), voice user interfaces (VUI), text based interfaces, mixed-modality interfaces, and the like. Interface 330 can include one or more graphical user interface elements including, but not limited to, text boxes, multiple selection fields, user interactive buttons, radio buttons, and the like.

The flowchart and block diagrams in FIGS. 1-3 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for zone based task management comprising:
identifying at least one of a plurality of tasks within a task manager application of a computing device, wherein the plurality of tasks is comprised of at least one of a plurality of planned activities;
determining a plurality of zones associated with at least one of the identified tasks, wherein each of the plurality of zones is associated with at least one bounded geographical region; and
estimating a task duration for the identified task based on user presence historical data associated with the plurality of zones.

2. The method of claim 1, wherein the zone associated with the task is at least one of a geometric shape and a free form shape.

3. The method of claim 1, wherein the zone associated with the task is defined by absolute geospatial coordinates comprising latitude and longitude.

4. The method of claim 1, further comprising:
collecting a plurality of user presence history data associated with a plurality of zones, wherein the user presence history data are at least one of a geographical location delta and a time duration.

5. The method of claim 1, wherein the task duration is a statistical average of a plurality of the user presence historical data associated with at least one of the zones.

6. The method of claim 1, wherein the zone based task duration estimate is presented within a user interface.

7. The method of claim 1, further comprising:
ranking a task list, wherein the task list is at least one of a plurality of zones based tasks and traditional tasks, wherein the ranking is based on at least one of shortest cumulative task duration and shortest navigation time.

8. The method of claim 7, wherein the ranking is associated with a confidence rating, wherein the confidence rating is an analytic confidence value.

9. The method of claim 7, further comprising:
applying a user specified ruleset to the ranked zone based task list.

10. The method of claim 7, wherein the ranked zone based task list is visually presented with a task list duration estimate, wherein the duration estimate is a value indicating the probable duration of time the task list is likely to require.

11. An interface for zone based task management comprising:
a user interface window for creating a zone corresponding to a geographic region, wherein the zone corresponds to a bounded geographic region;
a user interface window for establishing an activity and associating the activity with one or more zones; and
a user interface window for creating a zone based task and automatically estimating a task duration.

12. The interface of claim 11, further comprising:
a task management interface for modifying zone based tasks.

13. The interface of claim 11, wherein the task manager is associated with at least one of a navigation interface and a calendar interface.

14. A computer program product, which is digitally encoded in a tangible storage medium, for zone based task management comprising:
identifying at least one of a plurality of tasks within a task manager computer program product of a computing device, wherein the plurality of tasks is comprised of at least one of a plurality of planned activities;
determining at least one of a plurality of zones associated with the identified task, wherein each of the plurality of zones is defined by at least one bounded geographical region; and
estimating a task duration for the identified task based on user presence historical data associated with the determined zone.

15. The computer program product of claim 14, wherein the computer program product is an application programming interface capable of converting a traditional task within a task manager application into a zone based task.

16. The computer program product of claim 14, further comprising:
ranking a plurality of zone based tasks associated with a task list, wherein the ranking is based on at least one of shortest cumulative task duration and shortest navigation time.

17. The computer program product of claim 16, wherein the ranked zone based task list is visually presented.
